(19) United States
(12) Patent Application Publication
(10) Pub. No.: US 2023/0194707 A1
(43) Pub. Date: Jun. 22, 2023

(54) OBJECT DETECTION AND WARNING TRAINING BOARD

(71) Applicants: Gurpreet K. Juneja, Buffalo Grove, IL (US); Daksh Guard, Buffalo Grove, IL (US); Isha Guard, Buffalo Grove, IL (US); Atishay Patni, Buffalo Grove, IL (US); Pratyush Kumar, Buffalo Grove, IL (US)

(72) Inventors: Gurpreet K. Juneja, Buffalo Grove, IL (US); Daksh Guard, Buffalo Grove, IL (US); Isha Guard, Buffalo Grove, IL (US); Atishay Patni, Buffalo Grove, IL (US); Pratyush Kumar, Buffalo Grove, IL (US)

(21) Appl. No.: 17/882,818

(22) Filed: Aug. 8, 2022

Related U.S. Application Data
(60) Provisional application No. 63/290,637, filed on Dec. 16, 2021.

(51) Int. Cl. G01S 15/93; G01S 15/08; G09B 21/00; G08B 7/06; A63C 17/00; A63C 17/01

(52) U.S. Cl. CPC G01S 15/93; G01S 15/08; G09B 21/007; G08B 7/06; A63C 17/0006; A63C 17/01; A63C 2201/10; A63C 2203/22; A63C 2203/24

(57) ABSTRACT

A recreational and/or sports type transport (board) having an object detection and proximity warning system. The board uses sensors and calculates the distance from object, and then warns the user of the proximity of same through tactile and/or audio feedback.

### CROSS-REFERENCE TO RELATED APPLICATION

This application claims the benefit of U.S. Provisional Patent Application No. 63/290,637 filed Dec. 16, 2021, which is hereby incorporated by reference in its entirety herein.

### BACKGROUND OF THE INVENTION

### I. Field of the Invention

The present disclosure relates generally to a sport and recreation board with object detection and warning, and more particularly to a board having sensors to detect objects proximity therefrom and a transmitter to send such proximity to a device to warn the user thereof.

### II. Description of the Prior Art

There are multiple factors that have prevented many visually impaired individuals as well as children without social, physical or intellectual impairment, from attempting to explore the world of skateboarding. One of the main factors being that of a mental block or the fear of hitting an object. Another such factor is the almost complete lack of opportunities and/or resources. Indeed, the United States Association of Blind Athletes (USABA) is associated with very few blind skateboarders and is not aware of any resources to learn and promote through USABA. Accordingly, the world of skateboarding is not widely accessible to visually impaired children.

Numerous obstacle detection warning systems do exist to help visually impaired children move about and be active for daily necessities. By way of example, bionic eyes, wrist rangefinders, visor vision enhancers, and the like are available for visually impaired individuals, both children and adults alike. However, not a single product has been developed to encourage visually impaired youngsters to learn skateboarding independently, and thus the need remains.

The present disclosure addresses and fulfills this need. Accordingly, it is a general object of this disclosure to provide a system to encourage visually impaired youngsters to learn skateboarding independently.

It is another general object of this disclosure to provide a sport and recreational board with object detection and warning.

It is a more specific object of the present disclosure to provide a board with sensors and a transmitter.

It is another more specific object of this disclosure to provide a user engageable warning device.

Another more specific object of this disclosure is to provide a board with ultrasonic sensors.

Yet another more specific object of this disclosure is to provide a user wearable warning device.

These and other objects, features and advantages of this disclosure will be clearly understood through a consideration of the following detailed description.

### SUMMARY OF THE INVENTION

According to an embodiment of the present disclosure, there is provided an apparatus for user transport including a board with a front and a rear end. One or more sensors are positioned about the front of the board for determining transport path object proximity. A transmitter sends such proximity to a receiver which warns the user of distance/range.

According to an embodiment of the present disclosure there is also provided a system for user transport including a board with a front and a rear end. One or more sensors are positioned about the front of the board for determining transport path object proximity. A transmitter sends such proximity to a user engageable device which warns the user of object distance/range through tactile and/or audio feedback.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a frontal perspective view of the object detection training board according to the principles of an embodiment of the present disclosure.

FIG. 2 is a front perspective view of the wearable warning device for use with the board of FIG. 1.

FIG. 3 is a side view of the board of FIG. 1.

FIG. 4 is a bottom view of the board of FIG. 1.

FIG. 5 is a top view of the board of FIG. 1.

FIG. 6 is a front perspective view of a user wearing a warning device and on the board of FIG. 1.

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

While this disclosure will focus on a skateboarding system, it will be appreciated that any type of recreational and/or sports type transport may be used. For example, it is contemplated that snowboards and scooters would also work well. Furthermore, even skis, skates, cycles and the like are envisioned for this system. Indeed, any form of transport may be a candidate, and the use of “board” herein does not intend to limit same.

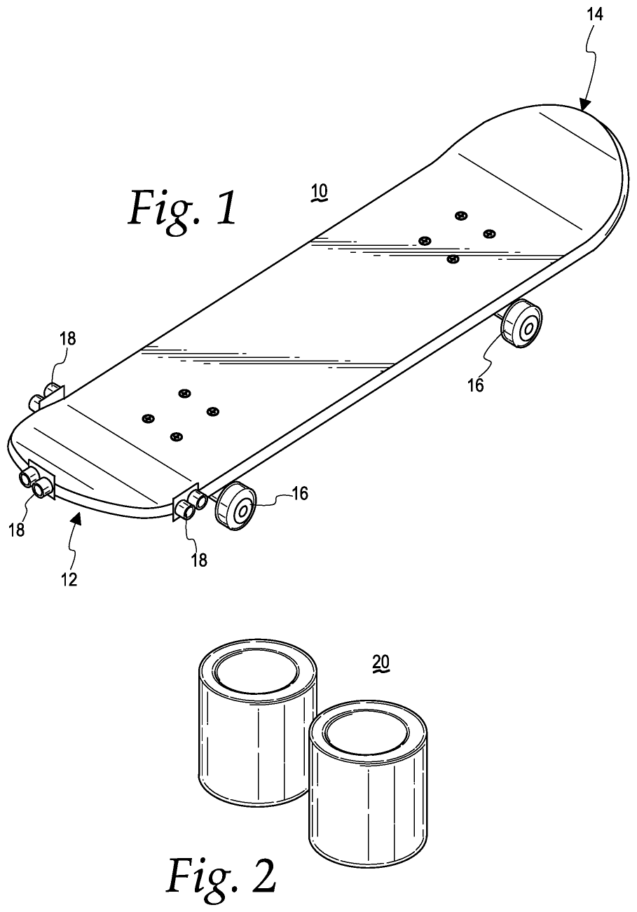

In any event, and turning now to a skateboarding embodiment, FIG. 1 shows a skateboard 10 having a front end 12, a rear end 14, and wheels 16. Sensors 18 are generally positioned about the front end 12 of the board 10. It will be appreciated that while three sensors are shown, the system can be designed to optimally utilize less than or more than three.

FIG. 2 shows two user warning devices, in particular, wristbands 20. It will be appreciated that the user warning device may take other forms. For example, a headband, ankle band, watch, eyewear, etc. Indeed, the device need not be of a wearable design, although wearable may be preferred. For example, it is contemplated that the system may utilize a software application (app) to aid with functionality of object detection, warnings, low battery, etc. Accordingly, the user warning device may be handheld, or otherwise, and may take the form of a so-called smartphone.

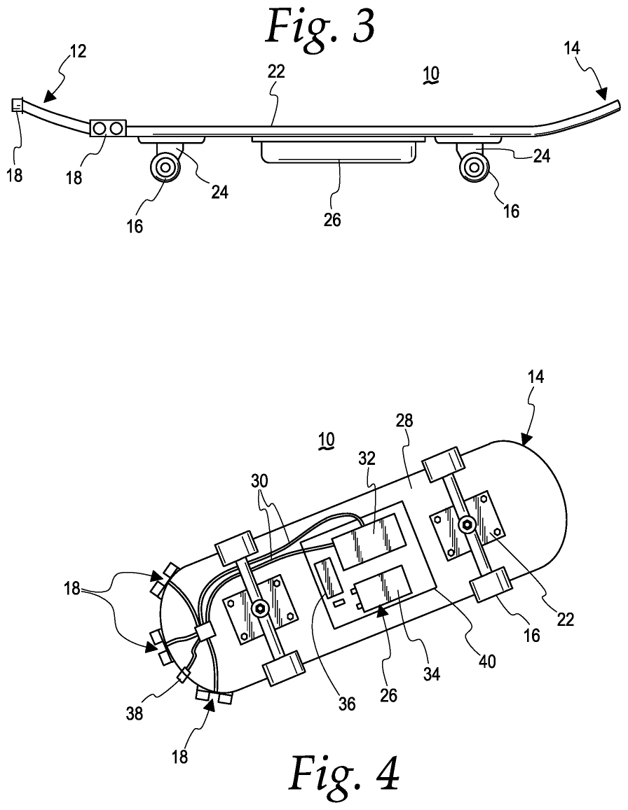

The side view of FIG. 3 illustrates the board 10 and its front 12 and rear 14 ends, top 22, and wheels 16 attached via trucks 24. The components of the present disclosure may be constructed as one with this typical skateboard or may be a retro-fit design. In any event, the sensors 18 and main assembly 26 are attached in a streamlined fashion.

The component parts are best shown as coupled to the bottom 28 of the board 10 in FIG. 4. In particular, the ultrasonic sensors 18 are positioned about the front end 12 and preferably are coupled to the main assembly 26 via wire tubes 30, although they may be wireless, as known in the art. The main assembly 26 may include a breadboard 32, ardino board 34 and power source 36 in the preferable form of a rechargeable battery. The assembly 26, upon determining (through a microprocessor, microcontroller or otherwise) object proximity by receiving input signals from the sensors 18, may transmit signals through a transmitter 38 and/or feedback communicator 40. This communicator, if integral with the board, may take the form of a vibrational motor (which the user would feel through their feet) and/or an audible buzzer or the like.

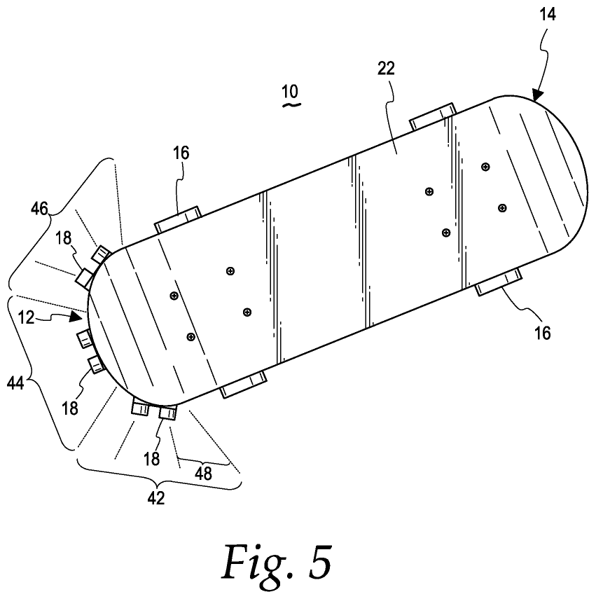

FIG. 5 shows an approximate degree of sensor pick-up with three sensors attached to the front end 12 of the board 10. In particular, each sensor 18 receives reflected sound waves from obstacles within a 90 degree arc consisting of three 30 degree arcs. As such, the sensors 18 provide for object detection in a generally left 42, front 44 and right 46 direction. It will be appreciated that any number of sensors 18 divided into any number of arcs 48 can be utilized depending upon array needs and wants.

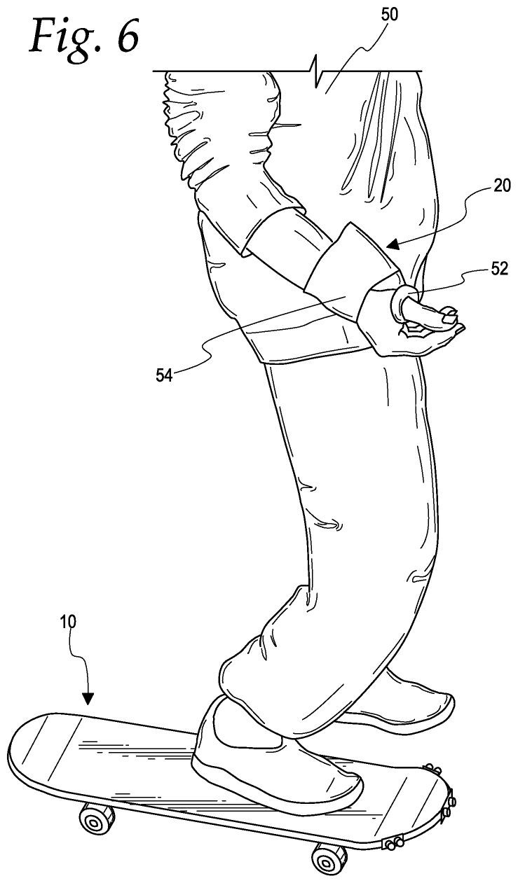

A user is shown atop a board 10 and wearing a warning device 20 in FIG. 6. This particular warning device 20 consists of an assembly 52 and a hook and loop strap 54. The warning device assembly 52 includes a receiver and a vibrational motor and/or buzzer. The vibrational motor is for tactile feedback and the passive buzzer provides pitch feedback.

Accordingly, in a preferred embodiment, the object detection and warning system consists of three ultrasonic sensors, vibration motor (tactile receptor) and passive buzzer (auditory receptor). The vibration motor and passive buzzer are embedded in a wristband, whereas the ultrasonic sensors are mounted around the nose of the board (skateboard). The vibration motor emits tactile feedback (something felt), and the passive buzzer creates a pitch or audible feedback (something heard).

When the user rides the skateboard on/down a transport path and comes across an obstacle in the path the ultrasonic sensors attached around the nose of the skateboard retrieves (e.g., 40 kHz) the reflected sound wave and the microcontroller (processor) calculates the distance from the object. The transmitter sends a signal (e.g., 2.4-2.5 GHz) to the receiver in the wristband. The vibration and/or audio signals may work alone or together in any number of different combinations to warn the user of the distance/range to the object. By way of example, and using pulse width modulation, if the distance/range is less than a certain threshold, then the buzzer creates an audible pitch and the vibration motor starts to rotate to alert the user. The audible pitch frequency increases as the user gets closer to the object thereby warning them of the nearing object.

An alternate embodiment may include the warning system attached/coupled directly to the board (e.g., feedback communicator 40), rather than a wearable warning device. The user would be able to feel the vibrating motor and/or hear the pitch.

Another alternate embodiment may include the warning system being part of an app for a smartphone. The smartphone is capable of both vibrating and audibly signaling the user. Such an app would enable the user to program threshold distance/range as well as further customizing the warning system.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. An apparatus for user transport comprising:
a board having a front end and a rear end;
one or more sensors generally positioned about said front end of said board for sensing an object in a transport path;
a processor for determining a distance between said board and said object;
a transmitter for sending a signal including object proximity; and
a receiver for receiving said signal and providing a warning to the user.

2. The apparatus as defined in claim 1 wherein said board is a skateboard.

3. The apparatus as defined in claim 1 wherein said sensors are ultrasonic sensors.

4. The apparatus as defined in claim 1 wherein said warning is tactile.

5. The apparatus as defined in claim 1 wherein said warning is audio.

6. The apparatus as defined in claim 1 wherein said warning is customizable.

7. A system for user transport comprising:
a board having a front end and a rear end;
one or more sensors generally positioned about said front end of said board for sensing an object in a transport path;
a processor for determining a distance between said board and said object;
a transmitter for sending a signal including object proximity; and
a user engageable warning device for receiving said signal and providing a warning to the user.

8. The system as defined in claim 7 wherein said board is a skateboard.

9. The system as defined in claim 7 wherein said sensors are ultrasonic.

10. The system as defined by claim 7 wherein said device is wearable.

11. The system as defined by claim 8 wherein said device is a wristband.

12. The system as defined by claim 7 wherein said device is a smartphone.

13. The system as defined by claim 7 wherein said warning is tactile.

14. The system as defined by claim 7 wherein said warning is audio.

15. The system as defined by claim 7 wherein said warning is customizable.
